(19) United States
(12) Patent Application Publication
(10) Pub. No.: US 2009/0095661 A1
(43) Pub. Date: Apr. 16, 2009

(54) SCREENING DEVICE

(75) Inventor: Biswadeep Paul, West Bengal (IN)

Correspondence Address: VENABLE LLP, P.O. BOX 34385, WASHINGTON, DC, 20043-9998, US

(73) Assignee: TEGA INDUSTRIES LIMITED, Kolkata (IN)

(21) Appl. No.: 12/282,500

(22) PCT Filed: Aug. 8, 2006
(86) PCT No.: PCT/IN2006/000283

§ 371 Date: Sep. 10, 2008

(30) Foreign Application Priority Data
Mar. 10, 2006 (IN) 203/KOL/06

(51) Int. Cl. B07B 1/46

(52) U.S. Cl. 209/409

(57) ABSTRACT

There is provided an improved screening device (A) comprising a screen panel with projections/rider bars (4) along the longitudinal direction of the top surface, (4B) said projections/rider bars being continuous or discreet and held to the base by bonding sliding or push fitting and provided between the adjacent screen openings apertures FIG. 2).

### FIELD OF THE INVENTION

This invention relates to an improved screening device.

This invention more particularly relates to an improved screening device having additional components (rider bars) on its top surface for screen mineral ores in mines, steel plants and other processing plants.

### BACKGROUND OF THE INVENTION AND PRIOR ART

Screen decks are used for screening mineral ores in mines, steel plants and other processing plants. However, the screen decks are subject to wear and tear and therefore, as decks are made of rubber or polyurethane, the life of such decks is limited. The need exists to increase the life of the screen decks made of rubber or polyurethane as well as help in better stratification and thereby better screening without adding much weight to the screen element.

### OBJECTS OF THE INVENTION

It is, therefore, an object of this invention to propose an improved screening device having an additional component (rider bar) on its top surface, which increases the life of the screen panel.

It is a further object of this invention to propose such an improved screening device, which improves the stratification.

Another object of this invention to propose such an improved screening device, which ensures a better screening than hither to possible.

### BRIEF STATEMENT OF THE INVENTION

Thus according to this invention there is provided an improved screening device comprising a screen panel with projections/rider bars along the longitudinal direction of the top surface, said projections/rider bars being continuous or discreet and held to the base by bonding sliding or push fitting and provided between the adjacent screen openings apertures.

The other features of the invention are as follows:
a) the said projections/rider bars are made of material selected from rubber and polyurethane.
b) the projections/rider bars are made of rubber, polyurethane with ceramic or hardox or both ceramic and hardox impregnated in it.
c) the said projection/rider bar further preferably includes inserts incorporated therein.
d) The said inserts are made from wear resistant material such as hardox, ceramic singly or in combination.
e) The said inserts are discreet or continuous.
f) an extension is provided at the bottom of the rider bar or slide fit.
g) The said projections/rider bar are of any cross section such as a trapezoid or any regular or irregular shape.

### BRIEF DESCRIPTION OF THE ACCOMPANYING DRAWINGS

The invention will now be explained with the help of the accompanying drawings where

FIG. 1 shows a front cross section of a known screen.

FIG. 2 to 5 show four different embodiments of the screen having four different types of rider bars on the top surface of the screen.

### DETAILED DESCRIPTION OF THE ACCOMPANYING DRAWINGS

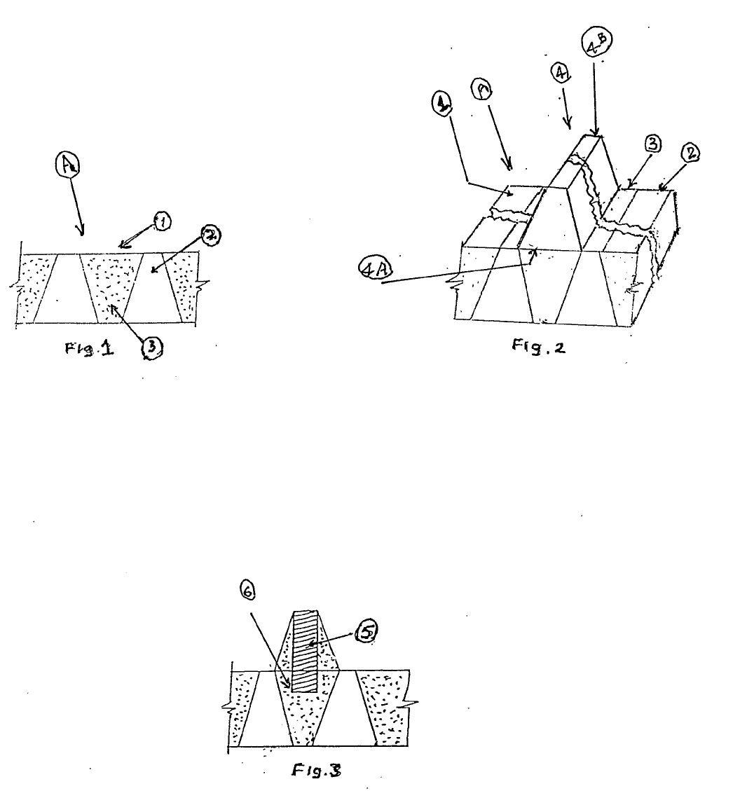

Referring to FIG. 1, the screen panel A, comprises a top surface (1), apertures/holes (2) which allow the material to pass through for separation and the apertures are separated by usual solid portions (3). Generally the top surface (1) is a flat or leveled surface and is made of rubber or polyurethane material.

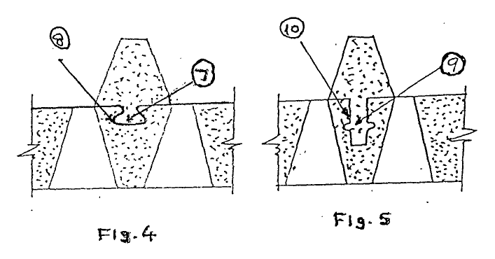

In accordance with the invention, FIGS. 2 to 5 exhibit four different kinds of rider bars mounted on the screen.

Referring to FIG. 2, it will be seen that it shows an isometric view of the screen with one type of rider bar . . . this screen has the usual top surface (1), apertures/holes/screen openings (2) and the usual solid portions (3).

In addition, there is provided a rider bar (4), (also called a projection) on a solid portion (3) of the screen extending longitudinally to the entire length of the screen or as may be required. Thus there can be one rider bar on each of the solid portion or on selected solid portions as may be considered necessary.

For efficient operations, these bars have a wider base (4A) and an uniformly tapering top surface (4B) preferably, removably provided on the solid portions (3) between the apertures (2). It is possible to have any shape of the projection, (rider bar) i.e. regular or irregular, and in a preferred embodiment it is trapezoidal in shape.

FIG. 3 shows another embodiment where there is provided an insert (5) from the top surface of the rider extending into a cavity (6) in the solid portion (3) of the screen . . . .

The insert may be continuous along the length of the rider bar or can be discreet cylindrical pieces incorporated into the rider bar. These projections or rider bars can be integrally bonded onto the solid surface of the screen or removably fitted.

FIG. 4 shows a dove tailed extension (7) at the bottom surface of the bar extending into a corresponding cavity. (8).

FIG. 5 shows another embodiment where there is provided a different type of extension (9) at the bottom surface of the bar extending into a cavity (10)

The projecting rider bar piece may be manufactured as a single element by moulding with the screen panel, or can be manufactured as a separated unit, which is replaceable.

A replaceable unit is advantageous in that in the event that the projecting rider bar is damaged, the entire panel need not be replaced or repaired. This saves on costs, and also increases the life of the panel considerably.

The life and efficiency of the screen decks made of rubber of polyurethane is increased, without adding much weight to the screen element by adding the projections (rider bars) on the top surface of the panel between the apertures to a predetermined height. These projections can be made of the same material as that of the screen or different materials impregnated in the base material of constructions of the panel. The projections may be made of materials such as rubber, polyurethane or even more wear resistant material like hardox, ceramic, to increase the life of the portion which is most wear prone.

The projections can be along the flow or across the flow of the material on the screen panel, and can be of any shape, i.e. rectangular section, semicircular trapezoidal S shaped, running straight or zig zag etc.

The different combinations of the base and projections may be polyurethane over polymethane panels, rubber over rubber panels.

In accordance with as preferred embodiment, the projections/rider bars may be further strengthened by incorporating inserts therein, made of wear resistant materials such as hardox, ceramic. The preferred combinations are hardox impregnated into polyurethane or rubber projections or ceramic impregnated into polyurethane or rubber projections or both hardox and ceramic embedded together in the rider bar.

Various embodiments as would be obvious from the description are also within the scope of the ensuing claims.

1. An improved screening device, comprising a screen panel, with projections/rider bars, along the longitudinal direction of the top surface, said projections/rider bars being continuous or discreet and held to the base by bonding, sliding or push-fitting and provided between the adjacent screen openings/apertures.

2. An improved screening device as claimed in claim 1 wherein said projections/rider bars are made of material selected from rubber and polyurethane.

3. An improved screening device as claimed in claim 1 wherein the projections/rider bars are made of rubber, polyurethane with ceramic or hardox or both ceramic hardox impregnated in it.

4. An improved screening device as claimed in claim 1 wherein said projections/rider bards further preferably include inserts incorporated therein.

5. An improved screening device as claimed in claim 4 wherein the inserts are made from wear resistant material such as hardox and ceramic, singly or in combination.

6. An improved screening device as claimed in claim 4 wherein inserts are discreet or continuous.

7. An improved screening device as claimed in claim 1 wherein an extension, is provided at the bottom of the rider bar for slide fit.

8. An improved screening device as claimed in claim 1 wherein set projections/rider bars are of any cross section such as trapezoid or any regular or irregular shape.
